(19) United States
(12) Patent Application Publication
(10) Pub. No.: US 2003/0225193 A1
(43) Pub. Date: Dec. 4, 2003

(54) Reinforced thermoplastic film composition

(76) Inventors: Dan Ben-Daat, Sharon, MA (US); Lou Lamarca, Hampton Falls, MA (US); Albert Roper, Westfud, MA (US); Matthew Williams, Cambridge, MA (US)

Correspondence Address: HAYES, SOLOWAY, HENNESSEY,, GROSSMAN & HAGE, P.C., 175 CANAL STREET, MANCHESTER, NH, 03101-2335, US

(21) Appl. No.: 09/990,790

(22) Filed: Nov. 14, 2001

(51) Int. Cl. C08K 5/49; C08K 3/10; C08K 5/02

(52) U.S. Cl. 524/115; 524/409; 524/464

(57) ABSTRACT

A composite reinforced thermoplastic sheet comprising a thermoplastic sheet and a fabric reinforcing layer adhered thereto, wherein the thermoplastic sheet comprises a polymer blend of ethylene-styrene interpolymer, polyolefin, and thermoplastic rubber and at least one fire retardant.

### FIELD OF THE INVENTION

The present invention generally relates thermoplastic film or sheet articles reinforced with a fabric material, and methods associated with the production of such materials via melt compounding procedures. Particular utility is directed at the use of such reinforced materials for vehicular applications.

### BACKGROUND OF THE INVENTION

Conventional polyvinyl chloride (PVC) is widely employed in automotive applications. PVC offers several advantages, especially low cost and relative ease of processing. However, one potential downside to PVC use relates to the degradation products that may result during incineration, such as hydrochloric acid, and recent concerns regarding the leaching of PVC components (additives) into ground water.

In addition, there has been a constant effort to reduce the number of different resins that may be employed in vehicular applications, so that when issues of recycling emerge, problems of mixing and incompatibility are relieved. In that context, there has been an ongoing effort to reduce the number of different resins in a vehicular application, which has routinely included multiple resin components. Of course, in the context of such efforts, the selection of resin alternatives that provide additional weight savings would be a corresponding and useful goal.

In consideration of such potential problems and concerns associated with the use of PVC, and the need to reduce the number of different resins employed in automotive applications, there has been a great deal of interest in finding a non-vinyl substitute suitable for automotive interior applications, such as vehicular seating and other upholstery applications, that avoids the problems inherent with vinyl interior components.

Along such lines, attention is directed to a variety of recent reports that discuss the virtues of ethylene/styrene interpolymers, which are said to offer a wide range of material structures and properties. See, e.g, U.S. Pat. Nos. 5,739,200; 5,973,049; 6,087,447; 6,136,923; 6,184,294 and WO 00/59723. These various disclosures are assigned to the Dow Chemical Company, Midland, Mich.

Accordingly, it is an object of this invention to develop and manufacture a a non-vinyl substitute suitable for, among other things, an automotive interior application, which makes use of the aforementioned ethylene-styrene interpolymer material in an appropriate blend with other indicated resins and additives.

In addition, it is also an object of this invention to develop such a blend of ethylene-styrene interpolymer, which is flame-retarded, developed and processed into a composite reinforced plastic sheet.

Finally, it is also an object of the present invention to develop such non-vinyl alternative so that such alternative will more readily recycle with the present polyolefin resins employed in vehicle applications, along with a significant weight savings.

### SUMMARY OF THE INVENTION

According to a first aspect, the invention herein embodies a thermoplastic film or sheet material adhered to a fabric support. The thermoplastic film or sheet of the first aspect comprises a polymer blend of ethylene-styrene interpolymer, polyolefin, and thermoplastic rubber. Additionally, the polymer blend comprises at least one fire retardant, preferably an antimony oxide, bromine, or phosphate fire retardant. Additionally, the polymer blend may comprise colorants and an ultraviolet stabilizing package. The fabric support, to which the polymer film or sheet is adhered, is preferably a non-woven or a knit fabric comprising polypropylene, polyester or other synthetic fiber.

Consistent with a second aspect, the present invention relates to a fabric reinforced thermoplastic film or sheet material. According to the second aspect the thermoplastic material is a polymer blend comprising ethylene-styrene interpolymer, thermoplastic polyurethane, and thermoplastic rubber. Additionally, the polymer blend may also comprise a fire retardant, such as an antimony oxide, bromine, or phosphate fire retardant. Finally, the polymer blend may also comprise colorants and ultraviolet stabilizing packages. The fabric reinforcement, or support, preferably comprises a non-woven or a knit fabric comprising polypropylene, polyester, or other synthetic fiber.

The fabric reinforced thermoplastic film compositions of the present invention are regarded as suitable for vehicular applications including seating coverings and interior trim features.

### BRIEF DESCRIPTION OF THE DRAWINGS

Exemplary embodiments of the invention are set forth in the following description and shown in the drawings, wherein

FIG. 1 is an enlarged cross-sectional view of a reinforced thermoplastic sheet consistent with the present invention; and

FIG. 2 is a schematic illustration of an exemplary method of producing a reinforced thermoplastic sheet consistent with the present invention.

### DETAILED DESCRIPTION OF THE INVENTION

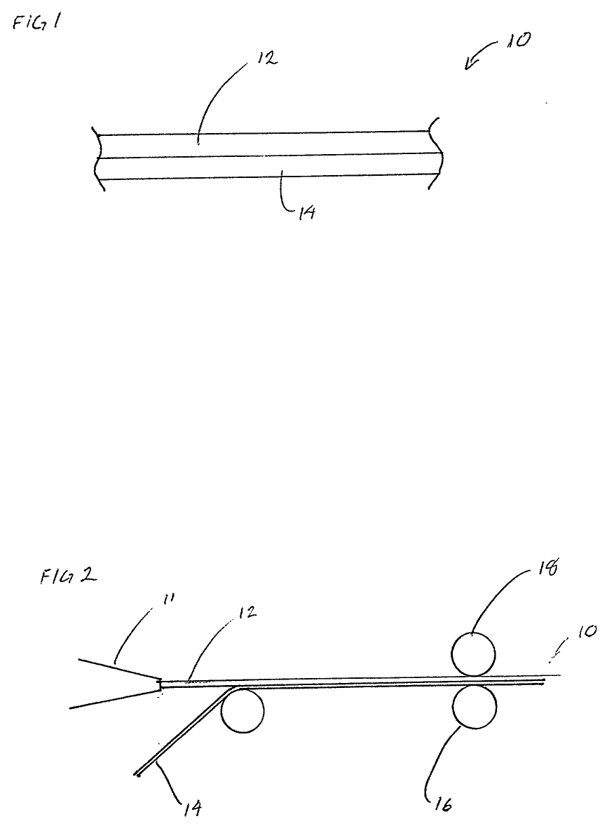

As illustrated in FIG. 1, the present invention is a composite reinforced thermoplastic sheet 10 comprising a first layer of a thermoplastic polymer blend 12 adhered to a fabric reinforcing layer 14. The thermoplastic polymer blend generally comprises a blend of ethylene-styrene interpolymer, polyolefin or thermoplastic polyurethane, and a thermoplastic rubber. Additionally, as desired, the polymer blend may also comprise flame retardants, colorants and ultraviolet stabilizers. The strength and durability of the thermoplastic sheet 12 are enhanced through the incorporation of a fabric reinforcing or support layer 14. The reinforcement provided by the fabric layer 14 renders the composite sheet 10 suitable for vehicular interior applications including seating coverings, interior trim feature coverings, and other upholstery applications.

Consistent with a first exemplary embodiment, the polymer blend may comprise an ethylene-styrene interpolymer blended with a metallocene polyolefin and a thermoplastic rubber. As used herein, ethylene-styrene interpolymer refers to a copolymer comprising ethylene and styrene repeat units and a preferred ethylene-stryene interpolymer is made by the Dow Chemical Company. The ethylene-styrene interpolymers which may be employed herein include the ethylene-styrene copolymers disclosed in the above referenced U.S. Pat. Nos. 5,739,200; 5,973,049; 6,087,447; 6,136,923; 6,184,294 and WO 00/59723.

According to this first blend composition, the metallocene polyolefin preferably comprises a metallocene, or other single site catalyzed polyethylene or polyethylene copolymer, rather than a traditional Ziegler/Natta catalyzed polyethylene. Those skilled in the art will recognize that such metallocene catalyzed polyethylene based resin are flow commercially available, as described below. The preferred thermoplastic rubber employed in this composition is an ethylene-propylene-diene rubber.

The polymer blend composition according to the first exemplary embodiment is preferably formulated to comprise between about 10-50% by wt. ethylene-styrene interpolymer, between about 20-70% by wt. metallocene polyethylene, and between about 10-30% by wt. ethylene-propylene-diene rubber. Additionally, it is desirable to incorporate between about 5-20% by wt. of a bromine or phosphate fire retardant. In addition to the bromine or phosphate fire retardant, it may be desirable to also employ an antimony oxide fire retardant. Finally, in the interest of aesthetics and increased service life of the final product, colorants and ultraviolet stabilizing packages may be also employed in the polymer blend.

An exemplary polymer blend formulation consistent with the first embodiment of the invention may be produced by the blending of approximately 30% by wt. metallocene polyethylene, such as ENGAGE™ metallocene catalyzed octene based polyethylene copolymer available from DuPont; approximately 30% by wt. ethylene rich ethylene/styrene interpolymer available from Dow Chemical Company; approximately 20% by wt. cross linked ethylene-propylene-diene rubber; approximately 15% by wt. bromine based fire retardant; approximately 5% by wt. of antimony trioxide fire retardant; and about 1% by wt. of an ultraviolet stabilizing package.

A second polymer blend formulation consistent with the present invention employs an aliphatic polyurethane in the place of the metallocene polyolefin. Accordingly, a second exemplary formulation generally comprises between about 10-50% by wt. of ethylene-styrene base interpolymer, between about 20-70% by wt. aliphatic polyurethane, and between about 10-30% by wt. of ethylene-propylene-diene rubber. Additionally, it is desirable to incorporate between about 5-20% by wt. of a bromine or phosphate fire retardant. Also, as in the first formulation a secondary antimony oxide fire retardant may be employed. Finally, it would also be desirable to incorporate colorants and ultraviolet stabilizing packages as necessary to fulfill aesthetic and service life requirements.

A specific exemplary formulation employing aliphatic polyurethane may comprise approximately 28% by wt. of aliphatic polyurethane, such as those commercially available from Huntsman or Bayer; approximately 24% by wt. of ethylene rich ethylene/styrene interpolymer; approximately 24% styrene rich ethylene/styrene interpolymer; approximately 15% by wt. bromine fire retardant; approximately 5% by wt. antimony trioxide fire retardant; approximately 3% by wt. colorant; and approximately 1% by wt. of an ultraviolet stabilizing package.

By reference to “ethylene rich” above, it is meant that the amount of ethylene component exceeds the amount of styrene component on a weight percentage basis. By the same token, by reference to “styrene rich”, it is meant that amount of styrene component exceeds the amount of ethylene component, also on a weight percent basis.

According to either embodiment of the polymer blend composition, the constituents of the polymer blend are preferably combined via melt compounding procedures. Exemplary compounding processes may include single and twin screw extrusion, injection molding, calendering, or the use of a Banbury mixer.

As employed with any of the polymer blends disclosed above, the fabric reinforcing layer 14 preferably comprises a generally light weight synthetic fabric. Exemplary reinforcing fabrics 14 may comprise polypropylene or polyester fabrics in the 2-6 oz./yd² weight range. Additionally, other synthetic fabrics, such a nylon or acrylic based fabrics may employed. In further embodiments, the fabric layer 14 may comprise more than one fiber material, i.e., a blend of different fiber compositions such as a polyester and a polypropylene, or a blend of two or more different fiber grades of the same composition, such as two different grades of polyester fiber.

With reference to FIG. 2, an exemplary method for manufacturing the reinforced thermoplastic sheet 10 consistent with the present invention is schematically illustrated. In the Exemplary embodiment the polymer blend may be continuously extruded from a sheet die 11. As the polymer blend sheet 12 is extruded from the sheet die 11, the polymer blend sheet 12 is laid on the fabric backing 14, which may be supported by idle roller 13, while the polymer blend sheet 12 is still molten. The layered structure comprising the polymer blend sheet 12 and the fabric backing 14 is subsequently passed through a pair of nip rollers 16 and 18. Preferably the nip rollers 16 and 18 comprise a rubber coated roller 16 in contact with the fabric backing, and a steel roller 18 that is in contact with the polymer blend sheet 12. As is commonly known, the nip rollers 16 and 18 may be configured to be co-rotating, whereby layered polymer blend 12 and fabric backing 14 are drawn through the nip rollers 16 and 18 by the rotating acting of the rollers 16 and 18. Furthermore, the gap between the nip rollers 16 and 18 is desirably adjusted to be less than the thickness of the layered polymer blend sheet 12 and the fabric backing 14, such that when the polymer blend sheet 12 and fabric backing 14 are drawn through the nip rollers 16 and 18 they are consolidated, and the still molten polymer blend sheet 12 is forced into the top, i.e., interfacial, layer of the fabric backing 14, therein enhancing the adhesion between polymer sheet 12 and the fabric backing 14.

Utilizing the method disclosed above, the reinforced thermoplastic sheet 10 may be prepared with a textured appearance. Surface texturing may be applied by providing the steel nip roller 18 with an embossed texture, such as a simulated leather grain or other texture. When the molten polymer blend sheet 12 is passed through the nip rollers 16 and 18, the applied pressure acts to transfer texture from the steel roller 18 to the surface of the polymer blend sheet.

In addition to the above described method for producing the reinforced thermoplastic sheet, consistent with the present invention the reinforced thermoplastic sheet may also be manufactured by methods including, but not limited to, calendaring, extrusion coating using a cross-head film coating die, compression molding of the fabric to the polymer blend sheet as a secondary operation, or flame laminating

It will be appreciated that the exemplary embodiment described and depicted in the accompanying drawings herein is for illustrative purposes only, and should not be interpreted as a limitation. It is obvious that many other embodiments, which will be readily apparent to those skilled in the art, may be made without departing materially from the spirit and scope of the invention as defined in the appended claims.

What is claimed is:

1. A composite reinforced thermoplastic sheet comprising a thermoplastic sheet and a fabric reinforcing layer adhered thereto, wherein said thermoplastic sheet comprises a polymer blend of ethylene-styrene interpolymer, polyolefin, and thermoplastic rubber and at least one fire retardant.

2. The reinforced thermoplastic sheet according to claim 1, wherein said at least one fire retardant is selected from the group consisting of: antimony trioxide, bromine fire retardant, and phosphate fire retardant.

3. The reinforced thermoplastic sheet according to claim 1, wherein said polymer blend further comprises a colorant.

4. The reinforced thermoplastic sheet according to claim 1, wherein said polymer blend further comprises an ultraviolet stabilizing package.

5. The reinforced thermoplastic sheet according to claim 1, wherein said polyolefin of said polymer blend comprises a metallocene polyethylene.

6. The reinforced thermoplastic sheet according to claim 1, wherein said thermoplastic rubber of said polymer blend comprises ethylene-propylene-diene rubber.

7. The reinforced thermoplastic sheet according to claim 1, wherein said polymer blend comprises between about 10-50% by wt. ethylene-styrene interpolymer, between about 20-70% by wt. polyolefin, and between about 10-30% by wt. thermoplastic rubber.

8. A composite reinforced thermoplastic sheet comprising a thermoplastic sheet and a fabric reinforcing layer adhered thereto, wherein said thermoplastic sheet is a polymer blend comprising about 30% by wt. ethylene rich ethylene-styrene interpolymer, about 30% by wt. metallocene polyethylene, about 20% by wt. ethylene-propylene-diene rubber, about 15% by wt. bromine fire retardant, about 5% by wt. antimony trioxide, and about 1% by wt. ultraviolet stabilizing package.

9. The reinforced thermoplastic sheet according to claim 8, wherein said fabric reinforcing layer comprises a polypropylene knit fabric having a basis weight of about 2-6 oz/yd².

10. The reinforced thermoplastic sheet according to claim 8, wherein said fabric reinforcing layer comprises a polyester knit fabric having a basis weight of about 2-6 oz/yd².

11. The reinforced thermoplastic sheet according to claim 8, wherein said fabric reinforcing layer comprises a polypropylene non-woven fabric having a basis weight of about 2-6 oz/yd².

12. The reinforced thermoplastic sheet according to claim 8, wherein said fabric reinforcing layer comprises a polyester non-woven fabric having a basis weight of about 2-6 oz/yd².

13. A composite reinforced thermoplastic sheet comprising a thermoplastic sheet and a fabric reinforcing layer adhered thereto, wherein said thermoplastic sheet comprises a polymer blend of ethylene-styrene interpolymer, polyurethane, and thermoplastic rubber and at least one fire retardant.

14. The reinforced thermoplastic sheet according to claim 13, wherein said at least one fire retardant is selected from the group consisting of: antimony trioxide, bromine fire retardant, and phosphate fire retardant.

15. The reinforced thermoplastic sheet according to claim 13, wherein said polymer blend further comprises a colorant.

16. The reinforced thermoplastic sheet according to claim 13, wherein said polymer blend further comprises an ultraviolet stabilizing package.

17. The reinforced thermoplastic sheet according to claim 13, wherein said polyurethane of said polymer blend comprises an aliphatic polyurethane.

18. The reinforced thermoplastic sheet according to claim 13, wherein said thermoplastic rubber of said polymer blend comprises ethylene-propylene-diene rubber.

19. The reinforced thermoplastic sheet according to claim 13, wherein said polymer blend comprises between about 10-50% by wt. ethylene-styrene interpolymer, between about 20-70% by wt. polyurethane, and between about 10-30% by wt. thermoplastic rubber.

20. A composite reinforced thermoplastic sheet comprising a thermoplastic sheet and a fabric reinforcing layer adhered thereto, wherein said thermoplastic sheet is a polymer blend comprising about 24% by wt. ethylene rich ethylene-styrene interpolymer, about 24% by wt. styrene rich ethylene-styrene interpolymer, about 28% by wt. aliphatic polyurethane, about 15% by wt. bromine fire retardant, about 5% by wt. antimony trioxide, about 3% by wt. colorant, and about 1% by wt. ultraviolet stabilizing package.

21. The reinforced thermoplastic sheet according to claim 20, wherein said fabric reinforcing layer comprises a polypropylene knit fabric having a basis weight of about 2-6 oz/yd².

22. The reinforced thermoplastic sheet according to claim 20, wherein said fabric reinforcing layer comprises a polyester knit fabric having a basis weight of about 2-6 oz/yd².

23. The reinforced thermoplastic sheet according to claim 20, wherein said fabric reinforcing layer comprises a polypropylene non-woven fabric having a basis weight of about 2-6 oz/yd².

24. The reinforced thermoplastic sheet according to claim 20, wherein said fabric reinforcing layer comprises a polyester non-woven fabric having a basis weight of about 2-6 oz/yd².
